(19) United States
(12) Patent Application Publication
(10) Pub. No.: US 2026/0017577 A1
(43) Pub. Date: Jan. 15, 2026

(54) OPERATING METHOD FOR A MEDICAL IMAGING SYSTEM

(71) Applicant: Siemens Healthineers AG, Forchheim (DE)

(72) Inventors: Lukas WAESCHLE, Ravensburg (DE); Kari KOSOG, Salt Lake City, UT (US); Mortiz GRUEN, Raleigh, NC (US)

(73) Assignee: Siemens Healthineers AG, Forchheim (DE)

(21) Appl. No.: 19/264,928

(22) Filed: Jul. 10, 2025

(30) Foreign Application Priority Data
Jul. 11, 2024 (DE) 10 2024 206 552.8

(51) Int. Cl. G06Q 10/0631; G09B 5/02; G09B 19/00

(52) U.S. Cl. CPC G06Q 10/063112; G06Q 10/063114; G09B 5/02; G09B 19/00

(57) ABSTRACT

One or more example embodiments relates to a computer-implemented method for use in a medical imaging system. The medical imaging system comprises at least one imaging modality which can be operated via remote control and at least one work station, remote from the at least one imaging modality, for at least one operator. A respective skill level is allocated to each of the at least one operator. The respective skill level indicates a competency of the operator to perform the medical imaging procedures with the at least one imaging modality. Data for a medical imaging procedure, which is to be performed, is captured with an imaging modality and an operator of the at least one operator is assigned to the imaging modality if the skill level allocated to the operator is below a requirement value specified for the medical imaging procedure to be performed.

### CROSS-REFERENCE TO RELATED APPLICATION(S)

The present application claims priority under 35 U.S.C. § 119 to German Patent Application No. 10 2024 206 552.8, filed Jul. 11, 2024, the entire contents of which are incorporated herein by reference.

### TECHNICAL FIELD

One or more example embodiments relates to operating methods for a medical imaging system, such as for a medical imaging system, which comprises an imaging modality which can be operated via remote control and a work station remote from the imaging modality.

Independent of the grammatical term usage, individuals with male, female or other gender identities are included within the term.

### RELATED ART

In modern medical facilities, expert knowledge of imaging is crucially important in order to carry out complex methods such as computed tomography or magnetic resonance imaging. These methods require not just highly specialized knowledge of the mode of operation of the imaging modalities, but also experience in the application and interpretation of the results. In general, the procedures are based on the physical presence of technologists or specialized medical staff throughout the imaging process.

However, health service providers increasingly find themselves confronted by the challenge that qualified specialists are often not available on site, in particular in rural or remote areas. This results in long waiting times or unnecessary journeys for patients and potentially even constitutes a danger to their health. Furthermore, particularly time-consuming measurements require the constant physical presence of a technologist during imaging, and this results in inefficiencies and ties up valuable work time.

In order to be able to access the required technical expert knowledge to perform medical imaging methods flexibly and as needed, it is possible to set up remote monitoring of imaging procedures. This solution is based on the idea that expert knowledge does not necessarily have to be on site, rather it can be provided from remote locations when it is required.

By using remote monitoring technologies, imaging procedures can be performed under the guidance and supervision of specialists, without them having to be physically present. This makes interaction possible between a remote work station, at which a qualified specialized medical member of staff is situated, and the imaging modality on site. This means that specialists no longer have to be local at the location of the imaging modality, rather their expertise can be brought in from remote locations.

More efficient use of expert knowledge and resources can consequently be achieved since specialists are no longer tied to a particular location, rather they can be flexibly deployed where and when their expertise is required. This can contribute not just to the optimization of workflows, but also makes it possible to care for patients better, in particular in rural or underserved areas, by preventing long waiting times or unnecessary journeys.

Despite this more efficient use of expert knowledge, in many countries throughout the world there is a staff shortage of 10-20%, and this results in long waiting times for patients, unutilized imaging modalities, unutilized remote workplaces, etc. Various approaches to improve the solution to this staff shortage are pursued with regard to the system components mentioned above, in particular imaging modalities and (remote) workplaces. For example, with the aid of artificial intelligence (AI) techniques in the field of imaging modalities, attempts are being made to automate workflows and to make operation possible for less qualified operators. Manufacturers of imaging modalities offer staffing services to provide radiology practices that are suffering from staff shortages with staff. The remotely monitored or remotely controlled imaging makes it possible for highly-qualified technologists to remotely operate imaging modalities and thereby make their skills remotely available and alleviate the lack of qualified staff. Manufacturers of imaging modalities can use this to offer remote imaging as a service. Scheduling programs can be used to make effective shift planning possible for the staff and the imaging modalities.

### SUMMARY

Despite the possibility of operating the imaging modalities remotely, there is frequently insufficient suitable specialized staff available, that is to say specialized staff with appropriate skills and experience, so examinations have to be deferred and/or it is not possible for imaging modalities to be used.

One or more example embodiments makes a flexible and needs-based allocation of expertise possible, as is required to perform medical imaging methods.

This is achieved by a computer-implemented method for use in a medical imaging system, by a medical imaging system and by a computer program product, which are defined in the independent claims. The dependent claims define embodiments.

### BRIEF DESCRIPTION OF THE DRAWINGS

FIG. 1 shows a medical imaging system for performing a medical imaging procedure according to one embodiment.

FIG. 2 shows a method for performing a medical imaging procedure according to one embodiment.

FIG. 3 shows an interaction of components of a medical imaging system according to one embodiment.

### DETAILED DESCRIPTION

One or more example embodiments relates to a computer-implemented method for use in a medical imaging system. The medical imaging system comprises at least one imaging modality which can be operated via remote control and at least one work station, remote from the at least one imaging modality, for at least one operator.

In the method, a respective skill level is allocated to each of the at least one operator. The respective skill level indicates a competency of the operator to perform medical imaging procedures with the at least one imaging modality. The skill level, which can also comprise several values, in principle indicates skills of the operator for different examinations with different devices. Different imaging procedures can refer, for example, to examinations of different organs, for example head, limbs or internal organs, or to examinations in relation to a current disease or a current suspicion of a disease, for example an oncological examination, an examination of bone fractures or an examination of injuries to internal organs. Different imaging modalities can comprise, for example, a magnetic resonance tomograph, an X-ray tomograph, a scintigraphy system, a positron emission tomography system, a sonography system, and the like. The skill level can comprise, for example, one or more imaging modality-specific skill levels. A respective imaging modality-specific skill level shows a competency of the operator to control a particular imaging modality. In further examples the skill level can comprise one or more imaging procedure-specific skill levels. A respective imaging procedure-specific skill level shows a competency of the operator to perform a medical imaging procedure with the imaging modality. The operator can comprise, for example, a technologist, in particular a medical technologist, or specialized medical staff.

In the method, data for a medical imaging procedure to be performed is also captured with an imaging modality of the at least one imaging modality. The data for the medical imaging procedure to be performed can comprise, for example patient-based data, data about a required imaging modality, data about a region of the body or an organ of interest, data relating to an initial suspicion of a disease of the patient to be examined, data about a current disease state of the patient to be examined or data about a planned date of the imaging procedure.

Finally, in the method, one operator of the at least one operator is allocated to the imaging modality, if the skill level allocated to the operator is below a requirement value specified for the medical imaging procedure to be performed, in order to participate in a performance of the medical imaging procedure via the remote work station. In some examples the data for the medical imaging procedure to be performed comprises the specified requirement value. In further examples the specified requirement value is determined from the data for the medical imaging procedure to be performed.

The allocation of an operator, whose skill level is below a requirement value specified for the medical imaging procedure to be performed, is based on the finding that, in practice, there is frequently no operator available to perform the medical imaging procedure who satisfies or exceeds the specified requirement value. However, since the medical imaging procedures are frequently planned fairly long-term, i.e. are pending only in a few days or weeks, for example, there is the possibility of improving the skills of an operator, who falls only slightly below the specified requirement value, such that on the date the medical imaging procedure is performed, the specified requirement value is satisfied. This can be considered, in particular, when a corresponding lack of operators is determined for particular medical imaging procedures, so a relevant course of instruction can permanently contribute to more individuals having an adequate qualification to perform this medical imaging procedure and consequently better use can be made of the imaging modalities and waiting times for the performance of medical imaging procedures can be reduced.

The method can be carried out, for example automatically, by a computing apparatus, for example a computer, a server or a computing apparatus of a Cloud service.

The skill level can comprise a dimensionless numerical value. In particular, the skill level can comprise a dimensionless numerical value in the range from 0 to 100. If more specific skill levels are allocated to an operator, for example the imaging modality-specific skill levels and/or imaging procedure-specific skill levels mentioned above, then each of these specific skill levels can likewise be indicated by a dimensionless numerical value in the range from, for example, 0 to 100. The corresponding requirement values can also be indicated as dimensionless numerical values, for example in the range from 0 to 100. Compliance with or satisfying a requirement can thus be easily determined by comparison of the corresponding numerical values. In particular, a discrepancy or gap between requirement and skill can also be ascertained and quantified.

For example, a further training measure for the assigned operator can be automatically defined as a function of the skill level of the assigned operator and/or the specified requirement value.

Preferably, the further training measure is terminated such that it takes place and is concluded before the medical imaging procedure is performed.

Various possibilities can be provided for performance of the further training measure. For example, the further training measure can be a Web-based further training measure at the remote work station. This makes it possible to perform the further training measure with a high degree of flexibility in relation to time and site. The operator can perform the further training measure at any date following assignment of the Web-based further training measure at, for example, the remote work station or even a home work station. Breaks in or spreading the further training measure over a plurality of appointed times is also possible to thus promote acceptance of the further training measure.

In further examples an automatic enrolment in a further training measure can be performed in a face-to-face lesson. This can take account of the fact that an identical, or at least similar, further training measure is planned for several operators. Performance of the further training measure in a face-to-face lesson can be terminated at a date which comes before the dates of the performance of the respective medical imaging procedures by the operators. The further training measure can consequently also be performed efficiently and promptly in a face-to-face lesson.

A further example of a further training measure is the participation of the operator in the medical imaging procedure, which is to be performed, as an observer at the remote work station. An operator, who already has considerable experience in the field of the allocated imaging modality and/or medical imaging procedure to be performed, but does not yet possess an adequate qualification to perform the medical imaging procedure independently on this imaging modality, can additionally be allocated to a more experienced operator of the imaging modality for the medical imaging procedure to be performed. The more experienced operator performs the imaging procedure while the operator who is not yet adequately qualified merely watches or performs individual portions of the imaging procedure, and is trained further as a result, under the supervision and at the direction of the more experienced operator.

A corresponding skill level, in particular imaging modality-specific skill levels and imaging procedure-specific skill levels, can be assigned to the respective operator in several ways. For example, a test can be performed at the remote work station. The test ascertains skills of the operator in relation to the medical imaging procedure to be performed. The test can also ascertain skills of the operator in relation to the imaging modality to be used, in particular in connection with the medical imaging procedure to be performed. A test can thus allocate imaging modality-specific skill levels as well as imaging procedure-specific skill levels. In a further example, results of the operator in face-to-face courses of instruction are captured and the skill level or the skill levels of the operator allocated and/or changed on this basis. Finally, according to a further example, medical imaging procedures, which the operator performed in the past, can be analyzed and the skill level or the skill levels of the operator allocated and/or changed on this basis. In particular, medical imaging procedures, which the operator performed in the past via the remote work station, can be analyzed in order to allocate and/or change the skill level or the skill levels of the operator on this basis. If the operator has already performed a high number of imaging procedures, for example in different regions, for example in the region of the head and the limbs, with a particular imaging modality and achieved good results in the process, for example a low number of faulty scans and/or rapid performance of the imaging procedures, the operator can be allotted to imaging procedures in further fields, for example in the cardiological field. This can be carried out, in particular, when the operator has performed these imaging procedures via the remote work station, i.e. has appropriate experience in operating the imaging modality remotely. Appropriate preliminary Web-based courses of instruction can be automatically offered to the operator or the operator can be allocated to a cardiological examination as an observer. Conversely, when it has been determined that an operator has made operating errors with particular imaging modalities or a hesitant and/or slow performance of an imaging procedure has been determined, this can result in the operator automatically being offered or assigned to an additional course of instruction.

In further exemplary embodiments, the method comprises setting a user interface, associated with the imaging modality, of a human-machine interface of the medical imaging system as a function of the skill level of the allocated operator. An operator, who has a high skill level, i.e., for example, a skill level which is significantly higher than the requirement value, can be presented, for example, with a user interface which is slightly more complicated to operate but in exchange makes fast operation possible and provides individual setting options for a large number of parameters. An operator, who does not possess such a high skill level, i.e., for example, a skill level which is in the region of the requirement value, can be presented, for example, with a user interface which guides the operator through an imaging procedure with corresponding help texts and provides only various standard settings for the large number of parameters.

In further examples, the operator is also assigned to the imaging modality as a function of availability data of the operator in order to participate in the performance of the medical imaging procedure via the remote work station. Efficient utilization of the imaging modality as well as the operator can consequently be achieved. The availability data of the operator can comprise, for example, items of information about normal working hours, shift times and/or absences of the operator.

One or more example embodiments relates to a processing apparatus for use in a medical imaging system. The medical imaging system comprises at least one imaging modality which can be operated via remote control and at least one work station, remote from the at least one imaging modality, for at least one operator, and the processing apparatus. The processing apparatus is embodied such that it allocates a respective skill level to each of the at least one operator. The respective skill level indicates a competency of the operator to perform medical imaging procedures with the at least one imaging modality. The processing apparatus is also capable of capturing data for a medical imaging procedure, which is to be performed, with an imaging modality of the at least one imaging modality. The medical imaging procedure to be performed is allocated one corresponding requirement value respectively. The processing apparatus assigns one operator of the at least one operator to the imaging modality if the skill level allocated to the operator is below the requirement value specified for the medical imaging procedure to be performed. As a result of the assignment of the operator to the imaging modality, the operator participates in a performance of the medical imaging procedure via the remote work station.

The processing apparatus can also be embodied to carry out the above-described method.

One or more example embodiments relates to a medical imaging system with at least one imaging modality which can be operated via a remote control, at least one work station, remote from the at least one imaging modality, for at least one operator and the previously described processing apparatus.

One or more example embodiments relates to a computer program product which comprises program elements which prompt a processing apparatus of a medical imaging system to carry out a method in that steps of the method are carried out by the processing apparatus when the program elements are loaded into a memory of the processing apparatus. The medical imaging system comprises at least one imaging modality which can be operated via remote control and at least one work station, remote from the at least one imaging modality, for at least one operator. The method comprises allocating a respective skill level to each of the at least one operator. The respective skill level indicates a competency of the operator to perform medical imaging procedures with the at least one imaging modality. The method also comprises capturing data for a medical imaging procedure, which is to be performed, with an imaging modality of the at least one imaging modality and assigning one operator of the at least one operator to the imaging modality, if the skill level allocated to the operator is below a requirement value specified for the medical imaging procedure to be performed, in order to participate in a performance of the medical imaging procedure via the remote work station.

A further aspect relates to a computer-readable medium on which program elements are stored which can be executed by a processing apparatus of a medical imaging system to carry out the above-described method in order to carry out the steps of the method when the program elements are executed by the processing apparatus.

The implementation of one or more example embodiments by a computer program product and/or a computer-readable medium has the advantage that even existing systems can be easily adapted by way of software updates in order to work as proposed by one or more example embodiments.

The computer program product can be, for example, a computer program or, apart from the computer program as such, can comprise a further element. This other element can be hardware, for example a storage apparatus on which the computer program is stored, a hardware key in order to use the computer program and the like, and/or software, for example documentation or a software key in order to use the computer program. The computer program product can also comprise development material, a run-time system and/or databases or libraries. The computer program product can be distributed among a plurality of computer instances.

The above-described properties, features and advantages and the manner in which they are achieved will become clearer and more comprehensible in conjunction with the following description of the exemplary embodiments which are explained in more detail in conjunction with the drawings.

Some examples of the present disclosure provide, in general, a large number of circuits or other electrical devices. All references to the circuits and other electrical devices and the functionality they provide should not be limited to only comprising that which is represented and described here. Even if particular designations can be assigned to the various circuits or other electrical apparatuses, these are not intended to limit the range of functions of the circuits and other electrical apparatuses.

It is clear that the following description of embodiments should not be understood in a limiting sense. The scope of the invention should not be limited by the embodiments described below or by the drawings, which serve solely for illustration.

The drawings should be regarded as schematic representations and the elements depicted in the drawings are not necessarily represented to scale, rather the various elements are represented such that their function and general purpose can be identified by a person skilled in the art. Each connection or coupling between functional blocks, apparatuses, components or other physical or functional units, which are represented in the drawings or described herein, can also be implemented by an indirect connection or coupling. A coupling between components can also be produced via a wireless connection. Functional blocks can be implemented in hardware, firmware, software or a combination thereof.

Some groups of elements, for example the imaging modalities or the workplaces, are identified by reference numerals which are formed of a number and optionally a following letter. Depending on context, the same reference numeral can designate a single element or all elements of the group. For example, each work station 104A, 104B, 104C is one of the plurality of workplaces 104. Identical reference numerals in the various drawings refer to similar or identical components.

Embodiments described herein provide a computer-implemented method which realizes a universal medical imaging system in order to fundamentally remedy the shortage of qualified operators for radiological apparatuses in diagnostic imaging (for example, MR, CT) and also to increase general staff efficiency in the field of radiology. Embodiments substantially relate to a computer-implemented method for operating apparatuses and agents which can be connected in the framework of radiological examinations. This comprises various components of the medical imaging system, for example imaging modalities (for example, MR scanners), operators (for example, technologists, such as medical-technical assistants), planning systems for radiological examinations and courses of study as well as teaching aids for training the operators.

In the case of the apparatuses and agents, measures can be taken to deploy operators efficiently and to use the imaging modalities efficiently. For example, artificial intelligence techniques can be used to at least partially automate a workflow when operating the imaging modalities and thus make it possible for the imaging modalities to also be operated by less qualified operators. Manufacturers of imaging modalities can provide a contingent of operators in order to compensate for staffing bottlenecks in customer systems. In particular, remote control techniques can be deployed to operate the customer systems from remote workstations. Further, planning software can be used to implement more targeted and more effective shift planning. A broad spectrum of learning opportunities can be provided for the training and further training of the operators, for example courses of instruction and electronic tutorials. The planning software can take the implementations of this training and further training into consideration.

The computer-implemented method can be embodied such that all of the above-mentioned components of the medical imaging system are connected to one another. For this, a quantitative skill level can be introduced as a shared means of communication between the components that are involved. Imaging modalities, skills profiles of operators, dynamic scheduling and training applications and training services can thereby form a mutually dependent system which makes it possible to optimize the distribution of skills throughout the system and to improve the skills. By using the skill levels it is possible to automatically and optimally assign the available operators to imaging procedures, which are to be performed, imaging modalities and learning opportunities, without human intervention.

The operators can comprise staff from the medical facilities or the manufacturer of the imaging modalities. The operators can be situated on site or at a remote work station.

A user interface of an imaging modality can be embodied in such a way that during operation of the imaging modality it can be switched between various operating modes. The operating modes can comprise, for example, an expert mode and a non-expert mode as well as further intermediate modes. An appropriate mode can be automatically set for the user interface using the skill level of the assigned operator. The user interface can also make continuous differentiation possible of, for example, 0 (non-experts) to 100 (experts).

Overall, an automatic system can be provided which optimizes a distribution of skills and improves knowledge of the operators. A self-regulating distribution dynamic can be achieved via the skill level by way of the behavior and the communication of all system components among themselves.

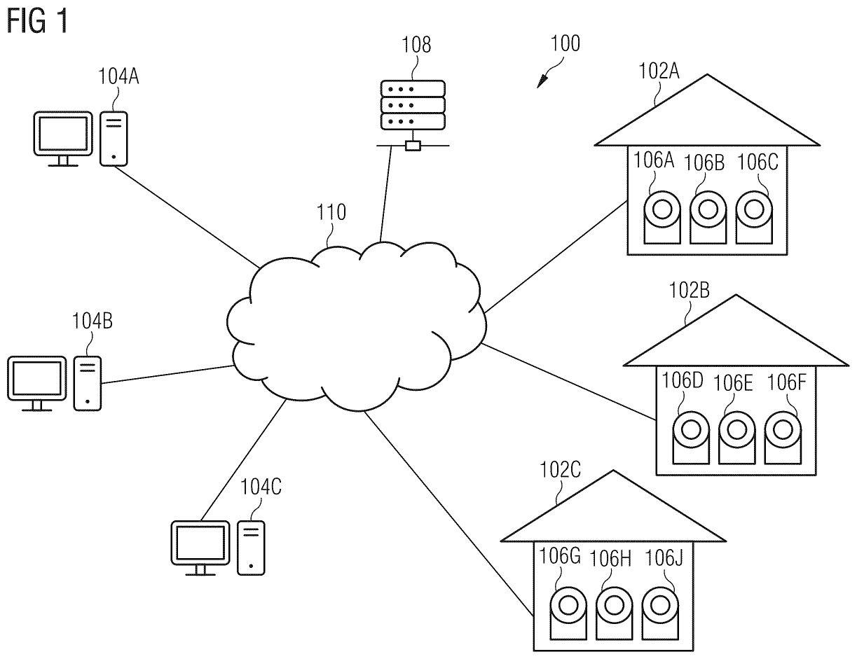

FIG. 1 shows a medical imaging system 100. The imaging system 100 comprises at least one imaging modality 106 which can be controlled remotely, at least one work station 104 remote from the at least one imaging modality 106 and a processing apparatus 108. The medical imaging system 100 comprises components and/or units which can be distributed over a spacious environment. Thus, individual system components can be situated at various locations or sites. System components can, however, also be situated at the same location.

The workplaces 104 can be allocated to operators who possess the skill to operate at least some of the imaging modalities 106. The workplaces 104 can be, for example, home workplaces or workplaces in a hospital, a radiological institute or at a manufacturer of the imaging modalities 106. Three workplaces 104A, 104B and 104C are provided in the example shown in FIG. 1. However, this number is only an example and any number of workplaces 104 can be provided, for example several hundred.

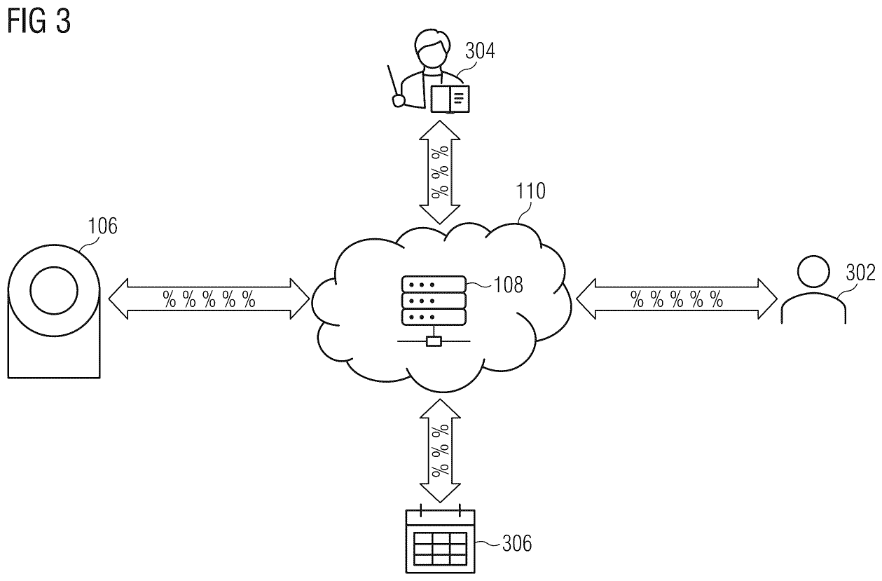

The imaging modalities 106 can be situated, for example, in medical facilities 102, for example in a hospital, a clinic or a radiological institute. Although FIG. 3 shows only three medical facilities 102A, 102B and 102C, the imaging modalities 106 can be accommodated in more than the three medical facilities 102 shown or in fewer than the medical facilities 102 shown.

The imaging modalities 106 can be, for example, CT, ultrasound, X-ray (for example, mammography), angiography or MRI systems, although other types of imaging modalities are equally possible. Nine imaging modalities 106A bis 106J are shown in the example shown in FIG. 1. However, this number is only an example and any number of imaging modalities 106 can be provided, for example tens, several hundred or more.

The medical facilities 102 and the imaging apparatuses 106 provided therein, the workplaces 104 and the processing apparatus 108 are connected together via a data transmission network 110. The data transmission network 110 can comprise one or more wired or wireless data transmission networks. The processing apparatus 108 can be, for example, a server. The processing apparatus 108 can comprise a plurality of processing apparatuses, for example a plurality of servers. The processing apparatus 108 can be provided in one of the medical facilities 102. The processing apparatus 108 can be provided in the data transmission network 110 as a Cloud service. The processing apparatus 108 can be provided in a data center for medical data processing. The processing apparatus 108 can comprise, for example, a microcontroller or an integrated circuit. The processing apparatus 108 can comprise hardware elements and/or software elements. The processing apparatus 108 can also comprise a storage unit which can be implemented as a temporary storage unit, for example, a random-access memory (RAM), or a permanent mass storage unit, for example hard disk, USB stick, SD card, solid state or the like. The processing apparatus 108 can have one or more interface(s) for communication with the imaging apparatuses 106 and the workplaces 104, for example via the data transmission network 110.

The workplaces 104 are positioned at a site remote from at least one of the medical imaging modalities 106. This means that a work station 104 can be realized as an independent service center remote from a medical facility 102. Alternatively, a work station 104 can be situated in a medical facility 102 or be an integral part of it. For example, the work station 104A can correspond to an expert/radiology center of the medical facility 102A. Accordingly, the work station 104A can provide technical/medical expert knowledge as a service for the remote medical facility 102B. The workplaces 104 each comprise a user interface unit which comprises an input unit and an output unit. The output unit can be configured to graphically visualize generated image data for an expert operator, who is situated at the work station 104 and is working there. The output unit can be configured to graphically visualize a graphical user interface for planning an imaging procedure or a corresponding protocol. Further, the output unit can be configured to visualize a chat window, making written or video communication with a local operator at the location of an imaging modality 106 possible. The output unit can equally be configured to output audio chat signals. The input unit can be configured to receive a user input (of a remote expert operator) with regard to the application in at least one imaging modality 106, procedure or protocol planning, for example adjusting a protocol parameter, written or audio chat input, or the like. The user interface units can comprise a screen or a display. They can also comprise a touch-sensitive screen, a keyboard, a mouse or a microphone and a loudspeaker.

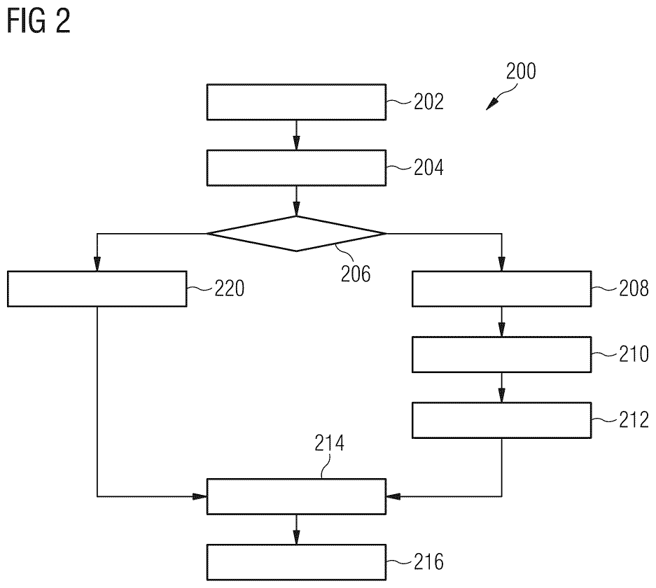

The medical imaging system 100 can be configured to carry out at least one medical imaging method. An exemplary method 200 is described below with reference to FIG. 2. The method 200 comprises method steps 202-216 which can be carried out at least partially by, for example, the processing apparatus 108.

In the method 200, a respective skill level is allocated in step 202 to each operator who is provided for operating one of the imaging modalities 106, for example directly on site or via a remote work station 104. The respective skill level indicates a competency of the operator to perform medical imaging procedures with the imaging modality 106. The skill level can indicate a plurality of skill levels or a skills profile of the operator. For example, a competency of the operator in relation to performing a particular medical imaging procedure with a particular imaging modality can be derived from the skill level.

A skill level of an operator can be determined, for example, by tests or exams that the operator takes. The tests can be performed, for example, at the remote work station 104 or in a training center. Furthermore, a skill level of an operator can be determined using medical imaging procedures which the operator has performed in the past. If an operator has, for example, already performed a large number of MRI examinations, the skill level for MRI examinations can be correspondingly high or be graded according to this. Extensive experience in examinations with different MRI imaging modalities can also increase the skill level in this regard. Similarly, extensive experience in performing medical imaging procedures of particular regions of the body or organs can increase a corresponding skill level.

Data for a medical imaging procedure to be performed is captured in step 204. The data can be input, for example by a physician who is treating a patient, into the processing apparatus 108 as a request for an imaging examination. The data for the medical imaging procedure to be performed comprises, for example, patient-based data, which could be relevant to the examination, for example contrast agent intolerances, pre-existing conditions and data about a current disease state of the patient to be examined. The patient-based data can also comprise personal data, such as date of birth name, address, height and/or weight. Further data can indicate, for example, which region of the body or organ is to be examined and whether there is an initial suspicion of a disease of the patient to be examined as well as more detailed items of information relating to it. Furthermore, the data can include items of information in relation to a required imaging modality, for example about what type of imaging modality is involved, such as CT, MRI or X-ray system, as well as items of information relating to the property of the imaging modality, such as an image resolution minimum requirement, processing speed, real-time capabilities, and the like. The data can also indicate a planned date of the imaging procedure or at least a time window and/or a planned site of performance or at least a region. Finally, the data can show a specified requirement value which indicates requirements made of the operator in order to perform the imaging procedure. The requirement value can refer to the performance of the imaging procedure as well as operation of the required imaging modality. The data can accordingly include a plurality of requirement values or a requirement profile. The requirement value can also be automatically determined from the above-mentioned data, for example via an AI system.

In step 206, the requirement value or the requirement profile for the medical imaging procedure to be performed is compared with the skill levels or the skills profiles of the operator. If an operator can be identified who satisfies the requirement value or the requirement profile and is available for the planned date of the imaging procedure, this operator is scheduled in step 220 to perform the imaging procedure. However, if it is not possible to identify an operator who satisfies the requirement value or the requirement profile and is available for the planned date of the imaging procedure, an operator who does not satisfy the requirement value or the requirement profile can thus nevertheless be scheduled in step 208 to perform the imaging procedure if there is still time for a corresponding further training measure before performance of the imaging procedure.

An operator can be assigned to a medical imaging procedure completely automatically. It can also be provided that each assignment, or at least each assignment in which the skill level of the operator is below the requirement value, is submitted to a supervisory authority, for example a head physician, senior physician or manager, and there is an option to reject this assignment. If an assignment is rejected, a new assignment can be sought in step 206 until an assignment is found which is not rejected by the supervisory authority.

A further training measure can be defined in step 210 for the operator thus assigned. The further training measure can be defined as a function of the skill level of the assigned operator and the specified requirement value. In particular, an operator can be provided, for example, to perform the imaging procedure whose skill level differs only slightly from the requirement value, so the operator can already become qualified to perform the imaging procedure by way of a minor further training measure. The further training measure is planned such that it can take place and be concluded before the medical imaging procedure.

A combined consideration of the skill levels of an operator is possible. If an operator has, for example, extensive experience in the field of different MRI imaging modalities and has also already performed a large number of medical imaging procedures on different organs or parts of the body, they can be considered suitable for MRI examination of an organ even though they have not yet performed this combination in the past. Further training (step 210) can be helpful in this case.

In another example, an operator can have extensive experience in the field of examination of a particular organ or a particular part of the body, for example of the knee, and have performed a large number of examinations in the past with, for example, a CT system. Experiences in the field of MRI examinations can be fewer. Despite this, an MRI examination of a knee can be assigned to the operator (step 208) and in addition, further training can be scheduled for the operation and peculiarities of the MRI imaging modality (step 210).

The further training measure can be performed in step 212. The further training measure can be, for example, a Web-based further training measure at the remote work station 104 of the operator. Successful participation in the Web-based further training measure can be automatically communicated to the processing apparatus 108. The processing apparatus can change, for example increase, the corresponding experience value for this individual.

If the individual was registered in step 208 for a further training measure in a face-to-face lesson, successful participation in this further training measure can be automatically stored in the processing apparatus 108 and the experience value adjusted accordingly.

Furthermore, the further training measure can be participation in the medical imaging procedure, which is to be performed, as an observer at the remote work station 104. In this case, two operators are allocated to the medical imaging procedure to be performed, one operator via steps 208-212, whereby this operator undergoes further training, and a further operator via step 220, who performs the medical imaging procedure in a controlling and/or leading role.

A user interface of a human-machine interface of the imaging modality 106, with which the medical imaging procedure is to be performed, can be set in step 214 as a function of the skill level of the allocated operator. For an operator with a lower skill level, i.e. less experience in dealing with the relevant imaging modality, it is possible to fade-in additional help texts, or to set rarely used parameters to standard values, and to fade-out on the user interface in order to facilitate operation and prevent operating errors. For an operator with a higher skill level, i.e. more experience in dealing with the relevant imaging modality, it is possible to offer more powerful and more complex operating elements on the user interface, which make faster and more efficient operation of the imaging modality possible.

The skill level of the allocated operator can be changed in step 216 after the medical imaging procedure has been performed. If, in addition to the leading operator, an operator was also allocated as an observer, the skill levels of both operators can be changed.

A dimensionless numerical value can be used as the skill level as well as the requirement value. The dimensionless numerical value can lie, for example, in the range from 0-100. However, this is just one example. In other examples the dimensionless numerical value can lie in the range from 0-1000 or in the range from 0-10. A numerical value range from 0-100 already offers sufficient opportunities for differentiation and still represents a compact and intuitive quantity.

FIG. 3 illustrates the effect of the skill level in the imaging system 100 between the operators 302, application planning 306, course of instruction measures and further training measures 304 as well as the imaging modalities 106.

Working times of the operators 302, times for further training measures 304 and times for performing medical imaging procedures on the imaging modalities 106 are compared via communication of the skill levels or requirement values, which are symbolized in FIG. 3 via the % sign. The comparison can be made, for example, via the processing apparatus 108.

The skills of the operators 302 are periodically updated and evaluated, for example, to be able to provide current skills profiles of the operators 302. The skills profile of an operator 302 can have, for example for each type of imaging modality or even for each type of device of an imaging modality, a corresponding imaging modality-specific skill level. Further, for each type of imaging procedure, for example procedures relating to examinations of particular organs or parts of the body, the skills profile of an operator can have a corresponding imaging procedure-specific skill level. During operation of an imaging modality, the imaging modality can supply data which shows how confident the operator is in dealing with the imaging modality, for example on the basis of operating errors or a speed at which the imaging modality is operated. This data can be used to increase or decrease corresponding skill levels of the operator.

When planning a medical imaging procedure an operator can be sought who has a skill level which is adequate for performing the medical imaging procedure with the imaging modality which is to be used. Gaps between requirement value and skill level can be tolerated within certain limits or compensated by appropriate further training measures. If, for example, a large number of urgent medical imaging procedures is pending, a larger gap can be tolerated. The gap can be reduced by, for example, a user interface of the imaging modality being set for less experienced operators. A high availability of an operator until the planned performance of the medical imaging procedure can be utilized in order to close a larger gap by way of a more extensive further training measure.

The further training measures 304 can be automatically selected on the basis of the skills profiles. A corresponding change in skill level can be allocated to each further training measure, which level can be applied to the skill level of the operator after successful participation of the operator in the further training measure. If an operator has, for example, extensive experience in dealing with MRI scanners, but still has very little experience in the field of cardiological examinations, appropriate further training for the field of cardiological examinations can thus be scheduled. Appropriate further training can comprise, for example, participation in a cardiological examination as an observer, which are automatically scheduled by taking into account availability data of the operators, such as normal working hours, shift times or absences. In particular, participation via the remote work station 104 makes flexible planning of participation in examinations and further training measures possible.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative used herein interpreted descriptors accordingly. In addition, when an element is referred to as being “between” two elements, the element may be the only element between the two elements, or one or more other intervening elements may be present.

Spatial and functional relationships between elements (for example, between modules) are described using various terms, including “on,” “connected,” “engaged,” “interfaced,” and “coupled.” Unless explicitly described as being “direct,” when a relationship between first and second elements is described in the disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” on, connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Also, the term “example” is intended to refer to an example or illustration.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless defined, all terms (including otherwise technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Specific structural and functional details disclosed herein are merely representative for purposes of describing example embodiments. The present invention may, however, be embodied in many alternate forms and should not be construed as limited to only the embodiments set forth herein.

In addition, or alternative, to that discussed above, units and/or devices according to one or more example embodiments may be implemented hardware, using software, and/or a combination thereof. For example, hardware devices may be implemented using processing circuitry such as, but not limited to, a processor, Central Processing Unit (CPU), a Graphics Processing Unit (GPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner. Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

Even further, any of the disclosed methods may be embodied in the form of a program or software. The program or software may be stored on a non-transitory computer readable medium and is adapted to perform any one of the aforementioned methods when run on a computer device (a device including a processor). Thus, the non-transitory, tangible computer readable medium, is adapted to store information and is adapted to interact with a data processing facility (also referred to as a data processing facility) or computer device to execute the program of any of the above mentioned embodiments and/or to perform the method of any of the above mentioned embodiments.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Although the present invention has been described in accordance with preferred embodiments, it is obvious for the person skilled in the art that modifications are possible in all embodiments.

Although the invention has been illustrated and described in detail by the preferred exemplary embodiments, it is not limited by the disclosed examples and a person skilled in the art can derive other variation herefrom without departing from the protective scope of the invention.

1. A computer-implemented method for use in a medical imaging system, wherein the medical imaging system provides at least one imaging modality which can be operated via remote control and at least one work station, remote from the at least one imaging modality, for at least one operator, the method comprising:
allocating a respective skill level to each of the at least one operator, the respective skill level indicating a competency of the operator to perform medical imaging procedures with the at least one imaging modality;
capturing data for a medical imaging procedure to be performed with an imaging modality of the at least one imaging modality; and
assigning an operator of the at least one operator to the imaging modality if the skill level allocated to the operator is below a requirement value specified for the medical imaging procedure to be performed to participate in a performance of the medical imaging procedure via the at least one work station.

2. The method of claim 1, further comprising:
defining a further training measure for the assigned operator as a function of at least one value from a group of values, wherein the group of values comprises the skill level of the assigned operator and the specified requirement value.

3. The method of claim 2, wherein the further training measure is terminated before the medical imaging procedure is performed.

4. The method of claim 1, wherein the allocating comprises at least one of the following:
performing a test at the at least one work station, the test ascertaining skills of the operator in relation to the medical imaging procedure to be performed;
capturing results of the operator in face-to-face courses of instruction; or
analyzing medical imaging procedures performed by the operator in the past.

5. The method of claim 1, further comprising:
setting a user interface of a human-machine interface of the medical imaging system as a function of the skill level of the allocated operator, the user interface associated with the imaging modality.

6. The method of claim 1, further comprising:
changing the skill level as a function of an analysis of the performance of the medical imaging procedure by the operator via the at least one work station.

7. The method of claim 1, wherein the skill level comprises a plurality of imaging modality-specific skill levels, wherein an imaging modality-specific skill level of the plurality of imaging modality-specific skill levels indicates a competency of the respective operator to control a particular imaging modality.

8. The method of claim 1, wherein the skill level comprises a plurality of imaging procedure-specific skill levels, and an imaging procedure-specific skill level shows a competency of the respective operator to perform a medical imaging procedure with the imaging modality.

9. The method of claim 1, wherein the skill level comprises a dimensionless numerical value.

10. The method of claim 1, wherein the skill level comprises a dimensionless numerical value in a range from 0 to 100.

11. The method of claim 1, wherein a further training measure comprises a further training measure from a group of further training measures, wherein the group of further training measures comprises:
a Web-based further training measure at the at least one work station,
participation in the medical imaging procedure to be performed as an observer at the at least one work station, and
an automatic enrolment in a further training measure in a face-to-face lesson.

12. The method of claim 1, wherein the operator is assigned to the imaging modality in order to participate in the performance of the medical imaging procedure via the at least one work station as a function of availability data of the operator.

13. The method of claim 12, wherein the availability data of the operator comprises items of information about at least one of normal working hours, shift times or absences of the operator.

14. The method of claim 1, wherein the data for the medical imaging procedure to be performed comprises at least one of the following groups of data:
patient-based data,
data about a required imaging modality,
data about a region of a body or an organ of interest,
data relating to an initial suspicion of a disease of a patient to be examined,
data about a current disease state of the patient to be examined,
data about a planned date of the imaging procedure, or
the specified requirement value.

15. The method of claim 1, wherein the specified requirement value is determined from the data for the medical imaging procedure to be performed.

16. A processing apparatus for use in a medical imaging system, wherein the medical imaging system comprises the processing apparatus, at least one imaging modality which can be operated via remote control and at least one work station, remote from the at least one imaging modality, for at least one operator,
wherein the processing apparatus is configured to
allocate a respective skill level to each of the at least one operator, the respective skill level indicating a competency of the operator to perform medical imaging procedures with the at least one imaging modality,
capture data for a medical imaging procedure, which is to be performed, with an imaging modality of the at least one imaging modality, and
assign one operator of the at least one operator to the imaging modality, if the skill level allocated to the operator is below a requirement value specified for the medical imaging procedure to be performed, in order to participate in a performance of the medical imaging procedure via the at least one work station.

17. A processing apparatus as claimed in claim 16, wherein the processing apparatus is configured to define a further training measure for the assigned operator as a function of at least one value from a group of values, wherein the group of values comprises the skill level of the assigned operator and the specified requirement value.

18. A medical imaging system, comprising:
at least one imaging modality operable via remote control,
at least one work station, remote from the at least one imaging modality, for at least one operator, and
the processing apparatus of claim 16.

19. A non-transitory computer-readable medium which comprises program elements which prompt a processing apparatus of a medical imaging system to carry out a method, wherein the medical imaging system provides at least one imaging modality which can be operated via remote control and comprises at least one work station, remote from the at least one imaging modality, for at least one operator, wherein the method comprises:
allocating a respective skill level to each of the at least one operator, wherein the respective skill level indicating a competency of the operator to perform medical imaging procedures with the at least one imaging modality,
capturing data for a medical imaging procedure, which is to be performed, with an imaging modality of the at least one imaging modality,
allocating an operator of the at least one operator to the imaging modality, if the skill level allocated to the operator is below a requirement value specified for the medical imaging procedure to be performed, in order to participate in a performance of the medical imaging procedure via the at least one work station.
